(19) United States
(12) Patent Application Publication
(10) Pub. No.: US 2002/0010931 A1
(43) Pub. Date: Jan. 24, 2002

(54) Method of viewing a live event

(76) Inventors: Brian O. Chew, Pittsburgh, PA (US); Wade M. Wilson, Pittsburgh, PA (US); Dave A. Foster, Pittsburgh, PA (US)

Correspondence Address: Dean E. Geibel, Webb Ziesenheim Logsdon Orkin & Hanson, P.C., 700 Koppers Building, 436 Seventh Avenue, Pittsburgh, PA, 15219-1818, US

(21) Appl. No.: 09/859,128

(22) Filed: May 16, 2001

Related U.S. Application Data
(60) Provisional application No. 60/219,710, filed on Jul. 19, 2000.

(51) Int. Cl. G06F 3/00; H04N 5/445

(52) U.S. Cl. 725/42

(57) ABSTRACT

A method for interactively viewing a live event generally including a plurality of video and audio signals which are transmitted to a receiver and a spectator chooses the particular signal that he or she wants to view and hear.

### CROSS-REFERENCE TO RELATED APPLICATION

This application claims the benefit of earlier filed U.S. Provisional Patent Application Ser. No. 60/219,710, filed Jul. 19, 2000, and entitled “Method of Viewing a Live Event.”

### BACKGROUND OF THE INVENTION

1. Field of the Invention

The present invention generally relates to an interactive method of experiencing an event and, more particularly, to a method of selecting scenes or sounds periodically interrupted with advertising.

2. Brief Description of the Prior Art

Events, either prerecorded or live, are often broadcast over television, radio, or the Internet. In most cases, the broadcast includes a single video feed and a single audio feed. A viewer passively watches and/or listens to the event and periodically occurring commercials through a broadcast reception device, such as a cathode ray tube or radio.

Passively viewing an event is extremely limiting because an individual can only see or hear what the broadcaster chooses to include in the broadcast. Therefore, interactive broadcasting systems have been developed to help solve the limitations inherent in passively viewing a broadcast.

One interactive broadcasting system is disclosed in U.S. Pat. No. 6,075,527 to Ichihashi et al., herein incorporated by reference in its entirety. The Ichihashi et al. patent illustrates an interactive television system wherein data is transferred from a broadcaster to a viewer and then from the viewer to the broadcaster. More specifically, the Ichihashi et al. patent describes transmitting additional information in the broadcast signal and further discloses using a standard telephone line to transmit information from the viewer back to the broadcaster. Examples of additional information transmitted by the broadcaster include golf course layout information, golf show summaries, trivia questions, and home shopping items. Information transmitted by the viewer to the broadcaster includes answers to trivia questions and credit card information.

While the Ichihashi et al. patent is clearly an advance in the broadcasting art, the additional information provided is only ancillary to the event itself. Therefore, additional approaches have been taken. Examples include U.S. Pat. Nos. 5,729,471 and 6,144,375, both to Jain et al., both herein incorporated by reference in their entirety.

### SUMMARY OF THE INVENTION

Interactive broadcasts are clearly a windfall for a spectator, since there is a great deal of flexibility and many more choices. However, the prior art does not address other facets of interactive broadcasts, such as advertising or marketing.

One embodiment of the present invention generally includes a method that allows a spectator to interactively experience a live or pre-recorded event through a broadcast reception device. The method generally includes the steps of creating a first signal which electronically represents a first portion of an event, creating a second signal which electronically represents a second portion of an event, creating a first advertisement signal which electronically represents an advertisement for a first product, creating a second advertisement signal which electronically represents an advertisement for a second product, interrupting the first signal with the first advertising signal, interrupting the second signal with the second advertising signal, delivering the first signal or the first advertising signal to the broadcast reception device, delivering the second signal or the second advertisement signal to the broadcast reception device, and allowing the spectator to select either the first signal/first advertisement signal or the second signal/second advertisement signal.

A second embodiment of the present invention is generally directed toward a method that allows a spectator to experience an event via a remotely-controlled broadcast signal converter. The second embodiment method generally includes the steps of creating a first signal which electronically represents a first portion of an event, providing a remotely-controlled broadcast signal concentrator operated by the spectator, creating a third signal which represents a third portion of an event as recorded by the broadcast signal converter, creating a first advertisement signal which electronically represents an advertisement for a first product, interrupting the first advertisement signal with the first signal, delivering the first signal/first advertisement signal and the third signal to the broadcast reception device, and allowing the spectator to select either the first signal/first advertisement signal or the third signal.

A third method according to the present invention is generally directed toward an interactive viewing method including the steps of creating a first signal which electronically represents a first portion of an event, creating a second signal which electronically represents a second portion of an event, providing a remotely-controlled broadcast signal concentrator operated by the spectator, creating a third signal which represents a third portion of an event as captured by the broadcast signal converter, creating a first advertisement signal which electronically represents an advertisement for a first product, interrupting the first advertisement signal with the first signal, delivering the first signal/first advertisement signal, the second signal/second advertising signal, and the third signal to the broadcast reception device, and allowing the spectator to select either the first signal/first advertisement signal, the second signal/second advertisement signal, or the third signal.

These and other advantages of the present invention will be clarified in the description of the preferred embodiment taken together with the attached drawings in which like reference numerals represent like elements throughout.

### BRIEF DESCRIPTION OF THE DRAWINGS

FIG. 1 is a flow chart of one possible embodiment of an electronic signal transmission configuration;

FIG. 2 is one possible embodiment of an on-screen menu display;

FIG. 3 is a flow chart of a method according to a first embodiment of the present invention that allows a spectator to experience an event via a broadcast reception device;

FIG. 4 is a flow chart of a method according to a second embodiment of the present invention that allows a spectator to experience an event through a remotely-controlled broadcast signal converter; and

FIG. 5 is a flow chart of a method according to a third embodiment of the present invention.

### DETAILED DESCRIPTION OF THE PREFERRED EMBODIMENTS

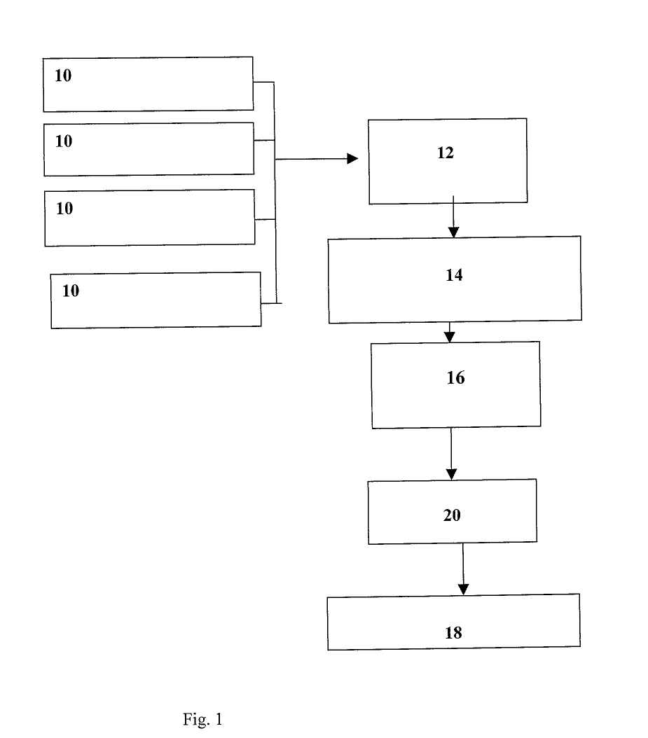

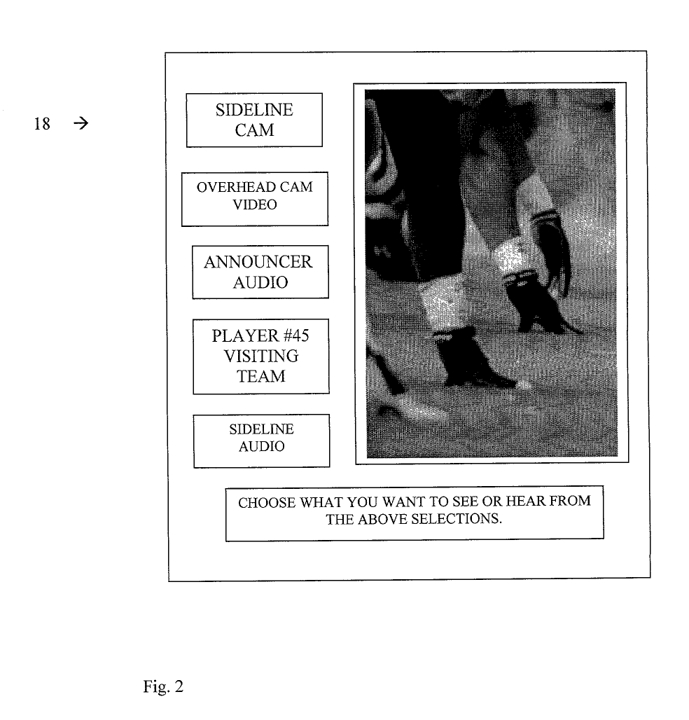

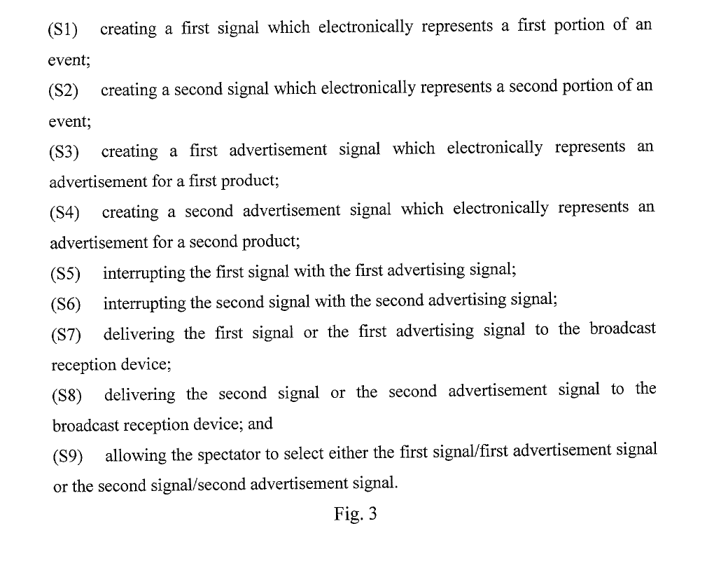

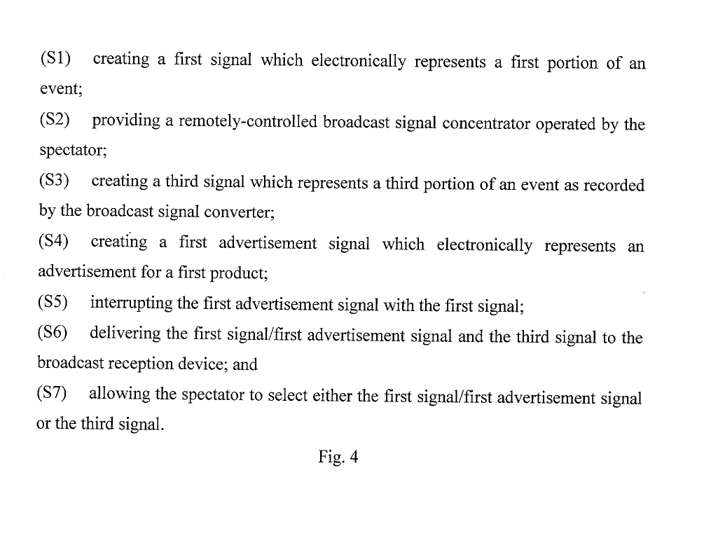

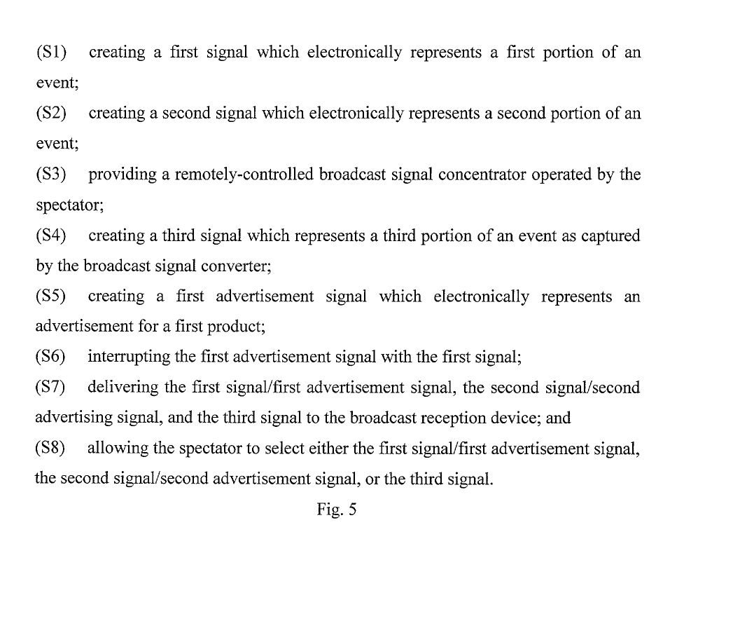

FIG. 1 generally shows one possible electronic signal transmission configuration according to one aspect of the present invention. FIG. 2 generally shows a sample output screen of a broadcast reception device 18. FIGS. 3-5 generally show three method embodiments according to the present invention.

As shown in FIG. 1, one possible electronic signal transmission configuration generally includes a plurality of broadcast signal converters 10 for generating a plurality of electronic video and/or audio signals which electrically represent portions of an event, an initial signal receiver 12 for collecting the plurality of video or audio signals, a signal transmission device 14 to transmit at least one and preferably two of the plurality of signals to a second signal receiver 16, a broadcast reception device 18, and a transmission medium 20 connecting the second signal receiver 16 to the broadcast reception device 18.

Each of the plurality of broadcast signal converters 10 converts visual images or audible sounds into electronic signals or waves. Broadcast signal converters 10 include, but are not limited to, television cameras, video tape recorders, microphones, or other suitable devices. Each broadcast signal converter 10 is positioned to receive a specific portion of the event and convert the image or sound into a signal or wave that electronically represents a portion of the event. The electronic signal or wave can be formatted for standard broadcast, high-definition broadcast, cable, Internet, WEBTV, three dimensional, one hundred and eighty degree cinema, or other applications.

Once a broadcast signal generator converts an image or sound into an electronic signal, such a first signal which represents a first portion of an event or a second signal which represents a second portion of an event, the electronic signal is sent to the initial signal receiver 12. The initial signal receiver 12 collects the first and second signals. On-screen menu information may be added. Moreover, the first signal may be interrupted by a first advertising signal or the second signal and may be periodically interrupted by a second advertising signal. Alternatively, advertising signals may also be designed to continuously or intermittently scroll across a portion of the reception device 18.

The first signal/first advertising signal and the second signal/second advertising signal, as well as any menu information, are then transmitted from the first signal receiver 12 using a signal transmission device 14, such as a television antenna, satellite feed, or other suitable device. An example of an Internet system is described in U.S. Pat. No. 6,078,962 to Mourad et al., herein incorporated by reference in its entirety.

The first signal or the first advertising signal and the second signal or the second advertising signal, as well as any menu information, are received by a second signal receiver 16, such as an antenna, a satellite dish, or a server, and are sent via a transmission medium 20, such as coaxial cable, fiber-optic cable, air, or other suitable medium, to the broadcast reception device 18. The transmission medium 20 should be capable of providing one-way or two-way transmission from the first signal receiver 12 to the second signal receiver 16. Examples of broadcast reception devices 18 include interactive television sets with speakers, computers with computer monitors and speakers, or other suitable devices capable of receiving video and/or sound inputs, displaying the video information on a screen, and/or playing the sound inputs.

When power is supplied to the broadcast reception device 18, the first signal, the first advertising signal, the second signal, or the second advertising signal, as well as any menu information, can be perceived by a spectator. In the case of video signals, choosing what is viewed may be accomplished by using a full screen or a frames architecture. In the case of full-screen applications, the menu information is not seen by the spectator until activated. Conversely, frames allow the on-screen menu information to be displayed in one portion of the screen and the video to be simultaneously displayed in a second portion of the screen. Audio signals can be chosen via similar architectures.

To change the feed from the first signal or the first advertising signal and the second signal or the second advertising signal, the spectator activates the non-selected signal using the on-screen menu information and a controller, such as a remote control, a mouse, a keyboard, or other suitable devices.

As shown generally in FIG. 2, a new menu item may be selected through hyperlinks, a plurality of picture-in-picture displays, pull-down menus, buttons, highlighted menu selections, or other suitable methods, and the broadcast reception device 18 displays the new video image or plays the new audio signal directly. Alternatively, the broadcast reception device 18 can also send a request to the second signal receiver 16. When the request is received, the second signal receiver 16 feeds the requested signal to the spectator through the broadcast reception device 18. In this second instance, a two-way transmission medium 20 is required. In yet another approach, a first spectator makes a selection and the request is sent to the second signal receiver. The selection of the first spectator is tabulated at the second signal receiver along with the selections of a plurality of other spectators, and the selection with the most requests is transmitted to the first spectator and the plurality of other spectators.

For the purpose of example only, and with reference to FIG. 3, consider a football game with a plurality of broadcast signal converters 10 converting visual images and audible sounds. The converters 10 can be positioned at different locations on the field, in a control room, in a helmet, on the sidelines, or in other suitable locations. The audio and video signals produced by all of the plurality of broadcast signal converters 10 are sent to the initial signal receiver. The receiver sends the plurality of signals, along with menu information describing the location of each of the plurality of broadcast signal converters 10, to the transmission device which transmits the signals to the second signal receiver 16. The second signal receiver 16 then transmits all or a portion of the signals, along with the menu information, to a broadcast reception device 18.

Using the broadcast reception device 18, a viewer selects the video signal that he or she wants to see and the audio signal that he or she wants to hear using the on-screen menu information. Again, for the purpose of example only, the viewer may select an overhead shot of the stadium and the audio signals generated by a selected player on one of the teams. Alternatively, the viewer may select a sideline view of the game and the audio signals being generated by professional announcers. In sum, any combination of video and audio signals can be selected, in real time, throughout the course of the game.

More particularly, a first embodiment of the present invention includes the steps of creating a first signal which represents a first portion of an event, creating a second signal which represents a second portion of an event, creating a first advertisement signal which represents a first product, creating a second advertisement signal which represents a second product, interjecting the first advertising signal into the first signal, interjecting the second advertising signal into the second signal, delivering the first signal, the first advertising signal, the second signal, and the second advertising signal to the reception device, and allowing the spectator to select either the first signal and the first advertisement signal or the second signal and the second advertisement signal.

There are numerous advantages to the first embodiment method. One advertiser can pay a fee to have the first advertising signal interrupting the first signal, while another advertiser can pay to have the second advertising signal interrupted the second signal. This allows broadcasters the flexibility of billing the same thirty-second spot to a plurality of advertisers. Aside from generating increased revenue for the broadcaster, advertisers are also provided with more opportunities to market their products.

A second embodiment of the present invention is generally directed toward a method that allows a spectator to interactively view an event through a remotely-controlled camera. The second embodiment method generally includes the steps of creating a first signal which represents a first portion of an event, providing a camera remotely controlled by the spectator, creating a third signal which represents a third portion of an event as recorded by the camera, creating a first advertisement signal which represents a first product, interjecting the first advertising signal into the first signal, delivering the first signal, the first advertising signal, and the third signal to the reception device, and allowing the spectator to select either the first signal/first advertisement signal or the third signal.

Under current procedures, broadcasters normally provide and operate broadcast signal converters 10. However, the present invention also contemplates allowing spectators to reserve, purchase, lease, or otherwise have access to a broadcast signal converter 10 which can be remotely controlled by the spectator. These broadcast signal converters 10, which may include audio converters, are preferably less sophisticated than a standard television broadcast camera and generally include a motor to allow movement of broadcast signal converter 10 about a fixed point, such as a permanent or mobile mount in an arena or stadium. After paying an access fee and receiving a code or other access key for one or more broadcast signal converters, a spectator can select the broadcast signal converter and can control the movement of the broadcast signal converter using an on-screen menu, joystick, or other suitable method or device.

The broadcast signal converters 10 controlled by a spectator provide a number of advantages. First, event promoters can sell more seats than the venue actually holds, since each broadcast signal converter 10 is analogous to another pair of eyes. Second, advertising can be eliminated from the signals converted by the remotely-controlled broadcast signal converters 10, adding incentive to purchase use of the remotely-controlled cameras. Third, some spectators may want to view the crowd, the sky, or some other attraction other than the event. Fourth, there is also the possibility that a certain status may be associated with those fortunate enough to have access to the remotely controlled broadcast signal converters, which may increase demand. Fifth, pay-per-vies events could increased fees for the opportunity to control one or more cameras.

The invention has been described with reference to the preferred embodiments. Obvious modifications and alterations will occur to others upon reading and understanding the preceding, detailed description. It is intended that the invention be construed as including all such modifications and alterations insofar as they come within the scope of the appended claims or the equivalents thereof.

We claim:

1. A method that allows a spectator to experience a live or pre-recorded event through a reception device comprising the steps of:
creating a first signal which electronically represents a first portion of an event;
creating a second signal which electronically represents a second portion of an event;
delivering the first signal to the broadcast reception device;
delivering the second signal to the broadcast reception device; and
allowing the spectator to select either the first signal or the second signal.

2. The method as claimed in claim 1 further comprising the step of creating a first advertisement signal which electronically represents an advertisement for a first product.

3. The method as claimed in claim 2 further comprising the step of creating a second advertisement signal which electronically represents an advertisement for a second product.

4. The method as claimed in claim 3 further comprising the step of interrupting the first signal with the first advertising signal.

5. The method as claimed in claim 4 further comprising the step of interrupting the second signal with the second advertising signal.

6. The method as claimed in claim 5 further comprising the step of delivering the first advertising signal to the broadcast reception device.

7. The method as claimed in claim 6 further comprising the step of delivering the second advertising signal to the broadcast reception device.

8. The method as claimed in claim 7 further comprising the step of allowing the spectator to select either the first signal/first advertising signal or the second signal/second advertising signal.

9. A method that allows a viewer to view an event through a remotely controlled camera comprising the steps of:
creating a first signal which electronically represents a first portion of an event;
providing a remotely-controlled broadcast signal concentrator operated by the spectator;
creating a third signal which represents a third portion of an event as recorded by the broadcast signal converter;
delivering the first signal signal and the third signal to the broadcast reception device; and
allowing the spectator to select either the first signal or the third signal.

10. The method as claimed in claim 9 further comprising the step of creating a first advertisement signal which electronically represents an advertisement for a first product.

11. The method as claimed in 10 further comprising the step of interrupting the first advertisement signal with the first signal.

12. An interactive viewing method comprising the steps of:
creating a first signal which electronically represents a first portion of an event;
creating a second signal which electronically represents a second portion of an event;
providing a remotely-controlled broadcast signal concentrator operated by the spectator;
creating a third signal which represents a third portion of an event as captured by the broadcast signal converter;
creating a first advertisement signal which electronically represents an advertisement for a first product;
interrupting the first advertisement signal with the first signal;
delivering the first signal/first advertisement signal, the second signal/second advertising signal, and the third signal to the broadcast reception device; and
allowing the spectator to select either the first signal/first advertisement signal, the second signal/second advertisement signal, or the third signal.
